(19) United States
(12) Patent Application Publication
(10) Pub. No.: US 2026/0343530 A1
(43) Pub. Date: Oct. 29, 2026

(54) LOW LATENCY INDICATION ENHANCEMENTS TO SERVE URGENT TRAFFIC

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/660,079

(22) Filed: Apr. 27, 2026

Related U.S. Application Data
(60) Provisional application No. 63/827,764, filed on Jun. 20, 2025.
(60) Provisional application No. 63/796,934, filed on Apr. 29, 2025.
(60) Provisional application No. 63/797,032, filed on Apr. 29, 2025.

(51) Int. Cl. H04W 72/1263

(52) U.S. Cl. CPC H04W 72/1263

(57) ABSTRACT

Embodiments of the present disclosure provide techniques for low latency indication (LLI) signaling and negotiation, including receiving, by the TXOP holder, a first control frame transmitted from a TXOP responder during a TXOP, the first control frame comprising an LLI and one or more traffic-related parameters associated with a traffic flow, determining, by the TXOP holder, whether to prioritize the traffic flow over one or more other traffic flows within a transmission queue by comparing the one or more traffic-related parameters of the traffic flow with traffic-related parameters of one or more other traffic flows, determining, by the TXOP holder, one or more scheduling parameters for the traffic flow based on the comparison, and transmitting, by the TXOP holder, a second control frame to the TXOP responder, the second control frame comprising the one or more scheduling parameters.

### CROSS-REFERENCE TO RELATED APPLICATIONS

This application claims benefit of co-pending United States provisional patent application Serial No. 63/796,934 filed Apr. 29, 2025, and co-pending United States provisional patent application Serial No. 63/797,032 filed Apr. 29, 2025; and co-pending United States provisional patent application Serial No. 63/827,764 filed Jun. 20, 2025. The aforementioned related patent applications are herein incorporated by reference in their entirety.

### TECHNICAL FIELD

Embodiments presented in this disclosure generally relate to wireless communication. More specifically, embodiments disclosed herein relate to low latency indication (LLI) signaling and negotiation.

### BACKGROUND

In wireless communication systems using transmit opportunity (TXOP)-based medium access, such as time division multiple access (TDMA) or orthogonal frequency division multiple access (OFDMA), transmissions are typically scheduled in advance, with traffic flows assigned specific transmission timings or resource units (RUs). Such scheduling enables efficient utilization of channel resources and supports predictable quality of service (QoS) for established traffic flows. However, in certain scenarios, urgent uplink (UL) or downlink (DL) traffic may arise dynamically, such as due to latency-sensitive or event-driven applications, and such traffic may require transmission with higher priority than the prescheduled traffic. Conventional scheduling mechanisms may not adequately account for such urgent traffic, leading to increased latency or missed timing limitations for the urgent traffic.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A depicts an example of trigger-based transmission with enhanced low latency indication (LLI) signaling, according to some embodiments of the present disclosure.

FIG. 1B depicts an example of trigger-based transmission with enhanced LLI signaling, according to some embodiments of the present disclosure.

FIG. 2A depicts an example of contention-based transmission with enhanced LLI signaling, according to some embodiments of the present disclosure.

FIG. 2B depicts an example of contention-based transmission with enhanced LLI signaling, according to some embodiments of the present disclosure.

FIG. 3 depicts an example of enhanced LLI signaling between APs for transmission of urgent traffic, according to some embodiments of the present disclosure.

FIG. 4 depicts an example of an extended LLI feedback element, according to some embodiments of the present disclosure.

FIG. 5 depicts an example signaling exchange between an AP MLD and a STA MLD for negotiation and termination of an LLI operating mode, according to some embodiments of the present disclosure.

FIG. 6 depicts an example method for scheduling urgent UL traffic based on enhanced LLI signaling, according to some embodiments of the present disclosure.

FIG. 7 depicts an example method for negotiation of an LLI operating mode, according to some embodiments of the present disclosure.

FIG. 8 is a block diagram depicting an example LLI signaling method, according to some embodiments of the present disclosure.

FIG. 9 is a block diagram depicting an example LLI negotiation method, according to some embodiments of the present disclosure.

FIG. 10 depicts an example network device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure provides a method, including receiving, by the TXOP holder, a first control frame transmitted from a TXOP responder during a TXOP, the first control frame comprising an LLI and one or more traffic-related parameters associated with a traffic flow, determining, by the TXOP holder, whether to prioritize the traffic flow over one or more other traffic flows within a transmission queue by comparing the one or more traffic-related parameters of the traffic flow with traffic-related parameters of one or more other traffic flows, determining, by the TXOP holder, one or more scheduling parameters for the traffic flow based on the comparison, and transmitting, by the TXOP holder, a second control frame to the TXOP responder, the second control frame comprising the one or more scheduling parameters.

One embodiment presented in this disclosure provides a method, including receiving, by a transmit opportunity (TXOP) holder and from a TXOP responder, a request frame associated with negotiation of a low latency indication (LLI) operating mode for a traffic flow, the request frame comprising one or more quality-of-service (QoS) parameters associated with the traffic flow, determining, by the TXOP holder, whether to allow use of the LLI operating mode for the traffic flow based on the one or more QoS parameters and one or more LLI policy constraints of the TXOP holder, and transmitting, by the TXOP holder, a response frame to the TXOP responder, the response frame indicating a result of the determination.

Other embodiments in this disclosure provide a computer program product comprising one or more computer-readable storage media collectively containing computer-readable program code that, when executed by operation of one or more computer processors, performs operations in accordance with one or more of the above methods, and a system of a network device comprising one or more computer processors, and one or more memories collectively containing one or more programs, which, when executed by the one or more computer processors, perform operations in accordance with one or more of the above methods.

### EXAMPLE EMBODIMENTS

In order to address transmission of urgent traffic in transmit opportunity (TXOP)-based wireless systems, such as those using time division multiple access (TDMA) or orthogonal frequency division multiple access (OFDMA) mechanisms, IEEE 802.11bn defines a Low Latency Indication (LLI) feature. In this feature, a station (STA), acting as a TXOP responder, can signal its low latency needs in an initial control response (ICR) frame, for example, a multi-STA block acknowledgment (BA) frame. An LLI field included in the Multi-STA BA frame enables the STA to indicate whether it has urgent low-latency traffic that requires transmission.

However, merely providing an indication that a STA has urgent low-latency traffic without providing any traffic-related details (e.g., a traffic identifier (TID), expiry time, or buffer status information) provides limited utility to an access point (AP) in making scheduling decisions. For example, without knowledge of the size of urgent traffic or its timing constraints, the AP cannot effectively determine whether to trigger uplink transmission within a current TXOP or a subsequent TXOP, nor can it determine an appropriate resource unit (RU) allocation.

In addition, in congested environments where multiple STAs signal LLI simultaneously, the absence of detailed traffic information prevents the AP from efficiently prioritizing among competing urgent traffic flows. As a result, the AP may be unable to satisfy latency requirements for certain traffic flows or may allocate resources inefficiently.

Some embodiments of the present disclosure provide methods, systems, and apparatuses for enhanced LLI signaling that conveys additional traffic-related parameters associated with urgent uplink (UL) or downlink (DL) traffic. Such parameters may include, for example, a traffic identifier (TID)/access category (AC)/stream classification service identifier (SCS ID), a buffer size, and/or an expiry time. Based on this information, a TXOP holder, which may be an AP or a STA, can determine appropriate scheduling actions, including prioritization among traffic flows, resource allocation, and transmission timing. In some embodiments, when the AP is the TXOP holder and the STA is a responder, the STA provides enhanced LLI information to assist the AP in scheduling UL or DL transmissions. In other embodiments, when the STA is the TXOP holder, the AP signals LLI information to request sharing or relinquishment of the TXOP in order to serve urgent UL or DL traffic.

In addition, the present disclosure describes mechanisms for enabling and controlling an LLI operating mode, including capability signaling, advertisement of LLI policies, and negotiation of LLI usage parameters at a per-traffic flow level (e.g., per SCS stream or per TID). The disclosure further describes verification of compliance with negotiated LLI policies, as well as dynamic modification or termination of LLI usage. Furthermore, some embodiments of the present disclosure include coordination between multiple APs in a coordinated time division multiple access (Co-TDMA) environment to enable sharing of TXOP resources based on LLI information associated with urgent traffic.

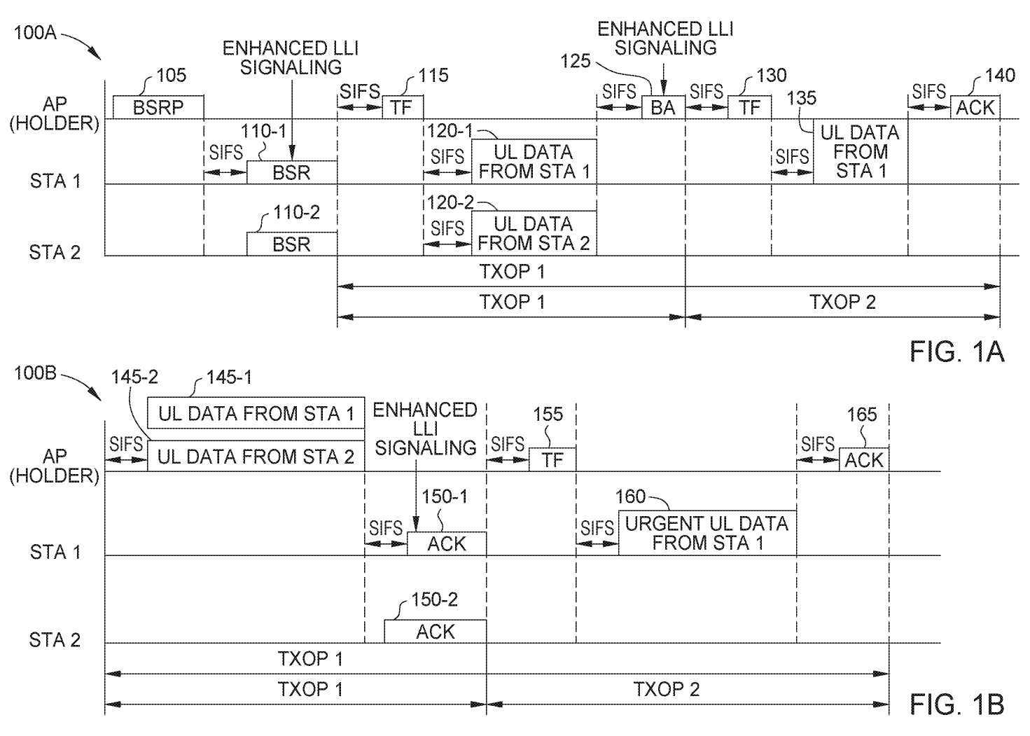

FIG. 1A depicts an example 100A of trigger-based uplink (UL) transmission with enhanced LLI signaling. In this embodiment, the access point (AP) operates as a TXOP holder and schedules UL transmissions to and from associated non-AP stations (STAs), including STA 1 and STA 2.

The AP may correspond to an AP multi-link device (MLD), and STA 1 and STA 2 may correspond to respective non-AP STAs or to affiliated station interfaces of a non-AP STA MLD.

Within the trigger-based UL transmission, the AP first transmits a buffer status report poll (BSRP) frame 105 to solicit buffer status information from associated STAs. In response, STA 1 and STA 2 transmit the corresponding buffer status report (BSR) frames 110-1 and 110-2, respectively. The BSR frames 110 provide buffer occupancy information that enables the AP to perform UL scheduling.

Based on the reported buffer occupancy information, the AP transmits a trigger frame (TF) 115 to allocate UL transmission resources. In response to the TF 115, STA 1 and STA 2 transmit UL data 120-1 and 120-2, respectively, using UL OFDMA or other multi-user transmission schemes. After receiving the UL transmissions, the AP transmits a multi-STA block acknowledgment (BA) frame 125 to acknowledge the reception of the UL data from multiple STAs.

In the illustrated embodiment, as depicted, STA 1 has urgent UL traffic requiring low-latency transmission. To signal this condition, STA 1 transmits enhanced LLI to the AP. As depicted, in one embodiment, the enhanced LLI is included in or embedded within the BSR 110-1 (e.g., piggybacked on the BSR) transmitted by STA 1 or within the multi-STA BA frame 125. The enhanced LLI provides additional context beyond conventional buffer status reporting and enables the AP to make scheduling decisions based on the urgency and latency requirements.

In some embodiments, the enhanced LLI are included in or embedded within other UL signaling, such as a quality-of-service (QoS) data frame, an acknowledgement (ACK) frame, a control frame, or a trigger-based UL response frame.

In one or more embodiments, the enhanced LLI corresponds to urgent UL traffic generated by an application requiring low latency, such as real-time or interactive services. The urgent traffic may be associated with one or more stream classification service (SCS) identifiers (IDs), traffic identifiers (TIDs), or access categories (ACs) that are configured to support latency-sensitive communication. For example, the urgent traffic may be mapped to a specific SCS stream, a high-priority TID, or an AC corresponding to latency-sensitive traffic. In some embodiments, the enhanced LLI indicates that such traffic is pending transmission and requires expedited scheduling due to strict latency limitations or timing requirements associated with the application.

The enhanced LLI signaling may include a low-latency indicator (e.g., an LLI field set to 1 to indicate the presence of urgent traffic) and one or more traffic-related parameters associated with low-latency traffic. The traffic-related parameters may include, but are not limited to, an indication of one or more ACs or TIDs corresponding to the urgent low-latency traffic. In some embodiments, one or more SCS IDs are included to indicate the SCS streams to which the urgent traffic belongs. The enhanced LLI signaling may further include information that indicates the size of the urgent low-latency traffic to be transmitted, such as based on the Queue Size associated with the corresponding TID of the low-latency traffic (e.g., using the Queue Size from QoS Control or from Enhanced BSR IEEE 802.11bn A-Control). Additionally, the enhanced LLI signaling may include an indication of an expiry time associated with the urgent traffic, such as a timing synchronization function (TSF)-based time value, to reflect latency limitations. In some embodiments, the enhanced LLI signaling further includes an indication requesting allocation or sharing of transmission resources (e.g., a portion of TXOP) to enable timely transmission of the urgent traffic.

In the embodiment shown in FIG. 1A, UL scheduling is performed based on buffer status reporting, where the AP transmits a BSRP frame and each of the STA 1 and STA 2 responds with a BSR to provide buffer status information. In some embodiments, a request to send (RTS)/clear to send (CTS) mechanism is used to reserve the channel prior to the TXOP. In such configurations, the enhanced LLI signaling may be conveyed using uplink signaling from the STA to the AP (e.g., being included in or embedded within the RTS). In some embodiments, the enhanced LLI may be included in another uplink control or data frame transmitted by the STA during channel access or reporting.

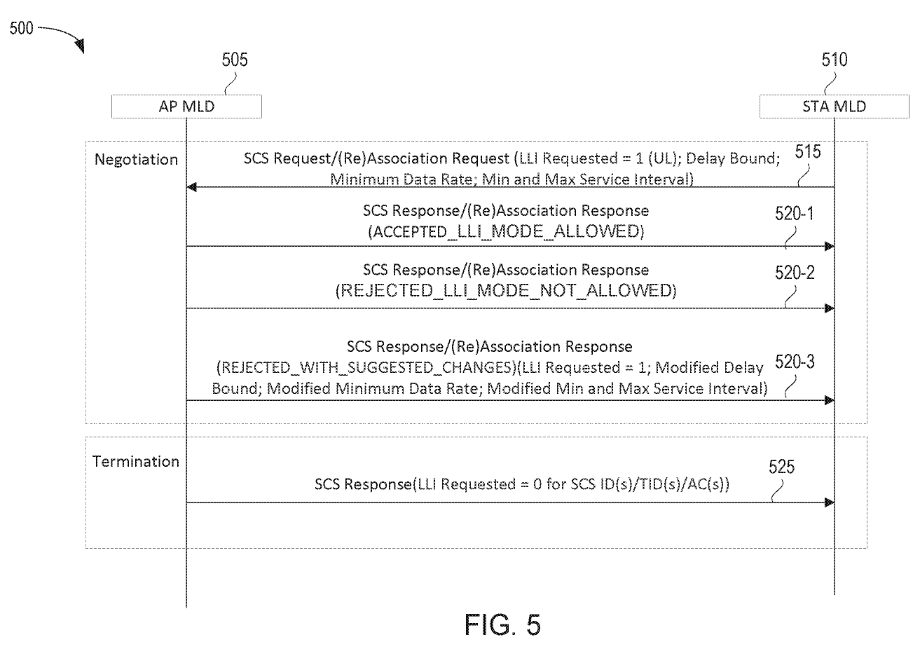

Upon receiving the enhanced LLI, the AP determines whether and how to schedule transmission of the urgent UL traffic. The decision may be based on one or more traffic-related parameters, including priority (e.g., indicated by the SCS ID(s)/TID(s)/AC(s)), queue size, and latency constraints, as well as one or more negotiated LLI policies or modes. In some embodiments, the LLI policies are negotiated for specific SCS IDs, TIDs, or ACs. Further details regarding LLI negotiation are described with reference to FIG. 5.

In the embodiment depicted in FIG. 1A, only STA 1 reports urgent uplink traffic. As shown, when an expiry time associated with the urgent traffic satisfies a predefined threshold condition (e.g., the remaining time before expiry is below a threshold) and when sufficient resources are available within the current TXOP (e.g., TXOP 1), the AP schedules the urgent uplink transmission within the same TXOP (e.g., TXOP 1) by transmitting an additional trigger frame 130. In response to the trigger frame 130, STA 1 transmits the urgent uplink data 135. The AP, in response, sends an acknowledgement (ACK) frame 140 to acknowledge the reception of the uplink data from STA 1.

When the expiry time does not satisfy the threshold condition, or when resources within the current TXOP (e.g., TXOP 1) are insufficient or otherwise unavailable, the AP may defer scheduling of the urgent uplink transmission to one or more subsequent TXOPs (e.g., TXOP 2). Within the subsequent TXOP (e.g., TXOP 2), the AP transmits a trigger frame 130, and STA 1 transmits the urgent uplink data 135 in response thereto, followed by a BA frame 140 transmitted by the AP.

The embodiment illustrated in FIG. 1A (where a single STA (e.g., STA 1) reports urgent uplink traffic) is provided for conceptual clarity. In some embodiments, multiple STAs (e.g., STA 1 and STA 2) may report urgent uplink traffic via enhanced LLI signaling embedded in BSRs, BAs, or other uplink signaling. In such cases, the AP may determine uplink scheduling by considering one or more shared traffic-related parameters associated with the urgent traffic, such as priority (e.g., based on TIDs, ACs, or SCS IDs), queue size, and expiry time.

In one embodiment, the AP prioritizes traffic based on the type of the urgent traffic (e.g., indicated by TID/AC/SCS ID). For example, if urgent traffic from STA 1 is mapped to TID 0 (e.g., best effort (BE)) and urgent traffic from STA 2 is mapped to TID 6 (e.g., voice (VO)), the AP may prioritize uplink triggering for STA 2 over STA 1. This may include scheduling UL transmission for STA 2 prior to STA 1 (e.g., within the current TXOP or one or more subsequent TXOPs).

In one embodiment, the AP uses queue size information to determine resource unit (RU) allocation when scheduling uplink transmissions. In some embodiments, the reported queue size corresponds specifically to urgent low-latency traffic. In other embodiments, when the STA is unable to distinguish urgent traffic from other traffic within the same TID, the reported queue size corresponds to the entire TID queue.

In one embodiment, the AP prioritizes transmissions based on latency limitations. For example, STA 1 may have urgent traffic with an expiry time of 2 milliseconds (ms) (e.g., pose data for an extended reality (XR) application), while STA 2 may have urgent traffic with an expiry time of 10 ms. In such a configuration, the AP may schedule STA 1 prior to STA 2 (e.g., within the current TXOP or one or more subsequent TXOPs).

In some embodiments, the AP considers multiple parameters jointly to determine scheduling decisions, including but not limited to priority (e.g., indicated by TID/AC/SCS ID), queue size, and expiry time. When resources permit, the AP may schedule multiple STAs simultaneously (e.g., assigning resource units (RUs) to STA 1 and STA 2) using uplink orthogonal frequency-division multiple access (UL OFDMA).

The enhanced LLI signaling enables the AP to obtain additional context regarding urgency and latency requirements of uplink traffic, and therefore allows more informed and efficient scheduling decisions. Without such information, the AP may be unable to distinguish urgent low-latency traffic from multiple STAs and cannot appropriately prioritize transmissions.

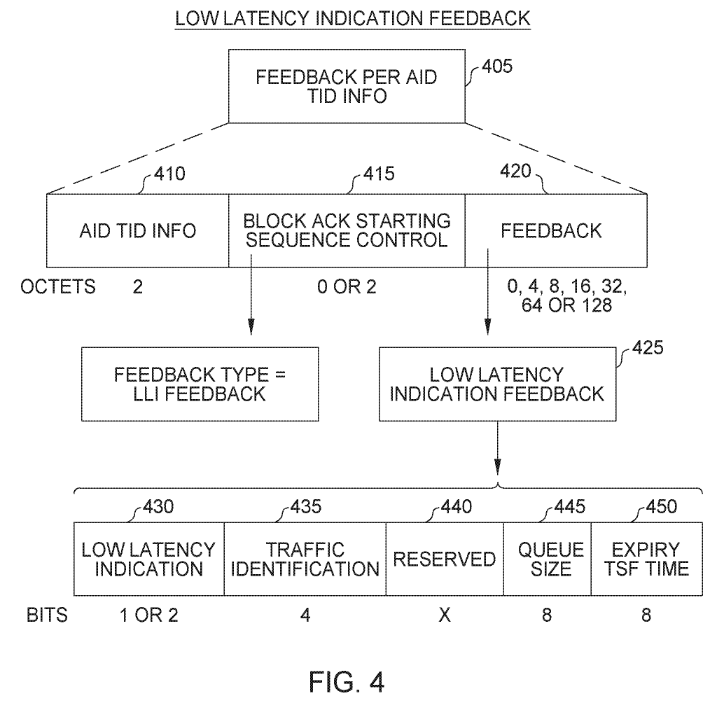

In one embodiment, one or more of the traffic-related parameters are carried using an extended LLI feedback element. The extended LLI feedback element may include one or more parameters associated with urgent low-latency traffic, such as a low latency indication, TID/AC/SCS ID, queue size, expiry time information (e.g., TSF-based timing), and/or a link identifier (link ID). Further details about the extended LLI feedback element are discussed below with reference to FIG. 4.

FIG. 1B depicts an example 100B of downlink (DL) transmission with enhanced LLI signaling. In this embodiment, the AP operates as a TXOP holder and transmits DL data 145-1 and 145-2, respectively, to the associated STA 1 and STA 2. In response to the DL transmission, STA 1 and STA 2 transmit corresponding ACK frames 150-1 and 150-2 to the AP.

The AP may correspond to an AP MLD, and STA 1 and STA 2 may correspond to respective non-AP STAs or to affiliated station interfaces of a non-AP STA MLD.

In the illustrated embodiment in FIG. 1B, STA 1 has urgent UL traffic to transmit. As depicted, STA 1 includes enhanced LLI in the ACK frame 150-1 transmitted to the AP. Based on the enhanced LLI, the AP determines whether and how to schedule transmission of the urgent UL traffic.

In one embodiment, when one or more conditions are satisfied (e.g., an expiry time meeting a predefined threshold or sufficient resources being available within the current TXOP), the AP schedules the urgent uplink transmission within the same TXOP (e.g., TXOP 1). In such a configuration, the AP transmits a trigger frame (TF) 155 within the TXOP, and STA 1 transmits urgent uplink data 160 in response thereto. The AP subsequently transmits an ACK frame 165 acknowledging the reception of the urgent uplink data.

In another embodiment, when the conditions are not satisfied (e.g., resources within the current TXOP being insufficient or unavailable), the AP defers scheduling of the urgent uplink transmission to a subsequent TXOP (e.g., TXOP 2), where a trigger frame 155 is transmitted to schedule the urgent uplink transmission. In response to the trigger frame 155, STA 1 transmits the urgent uplink data 160. The AP, in response, sends an ACK frame 165 to acknowledge reception of the uplink data from STA 1.

In some embodiments, multiple STAs (e.g., STA 1 and STA 2) each report urgent uplink traffic via enhanced LLI included in their respective ACK frames, BA frames, or other uplink signaling. In such configurations, the AP may determine scheduling by considering one or more traffic-related parameters associated with the urgent traffic, such as priority (e.g., based on TID/AC/SCS ID), queue size, and expiry time. Based on these parameters, the AP may prioritize one STA over another or schedule multiple STAs using uplink multi-user transmission (e.g., UL OFDMA).

In the embodiment illustrated in FIG. 1B, the enhanced LLI signaling is included in the ACK frame 150-1 transmitted by the STA 1 in response to downlink transmission. In some embodiments, the enhanced LLI signaling is included in other uplink signaling, such as a QoS data frame or another uplink control or data frame transmitted by the STA. In some embodiments, an RTS/CTS mechanism is used for channel reservation, and the enhanced LLI signaling is conveyed using an uplink control frame associated with such channel access. As discussed above, an extended LLI feedback element within these frames may be used to carry one or more traffic-related parameters (e.g., link ID, AC/TID/SCS ID, queue size, expiry time) associated with urgent low-latency traffic.

The enhanced LLI signaling depicted within FIGS. 1A and 1B is applicable when both the AP and the non-AP STA (e.g., STA 1 and STA 2) support an LLI feature or operate in an LLI mode. However, not all APs or non-AP STAs may support such functionality. Accordingly, in some embodiments, the AP and the non-AP STA first determine mutual support for LLI operation prior to using enhanced LLI signaling. When one of the entities does not support the LLI mode, the enhanced LLI signaling may be disabled, avoiding unnecessary overhead associated with transmitting unsupported information.

In one embodiment, both the AP and the non-AP STA indicate support for the LLI operation mode using capability signaling. For example, support for LLI may be indicated in an ultra-high reliability (UHR) Capabilities element. For example, a bit in a UHR MAC Capabilities field is set to indicate that low latency indication is supported. The AP may further signal one or more policies associated with LLI operation. Such policies may specify conditions under which LLI signaling is permitted. These policies may include, but are not limited to, (1) the AP allows enhanced LLI signaling (as depicted in FIGS. 1A and 1B) to be provided by non-AP STAs only when the LLI mode is explicitly enabled in the network; (2) the AP allows enhanced LLI signaling only for traffic associated with a selected set of ACs, TIDs, or flows having configured SCS streams; (3) the AP allows enhanced LLI signaling only when a delay bound of urgent traffic is less than or equal to an AP specified threshold (e.g., 5 ms); (4) the AP allows enhanced LLI signaling only when an expiry time of urgent traffic is within a threshold (e.g., 5 ms) specified by the AP; (5) the AP allows enhanced LLI signaling only for certain traffic flows identified based on traffic classification information (e.g., TCLAS, SCS ID, fully qualified domain name (FQDN)); (6) the AP requires negotiation with a non-AP STA prior to enabling use of the LLI mode; or (7) the AP requires negotiation for use of LLI mode with a non-AP STA only when the requested LLI operation falls outside the LLI policies advertised by the AP.

In one embodiment, the AP indicates that LLI mode is enabled within the basic service set (BSS) using a bit in a UHR Operation element. A non-AP STA may explicitly enable its use of LLI mode with the AP through an operating mode negotiation procedure. In some embodiments, a UHR operating mode notification framework (e.g., the frameworks used for non-primary channel access (NPCA), sub-band operation (DSO), or dynamic bandwidth expansion (DBE)) is used to enable/disable the LLI operating mode. In such configurations, the non-AP STA indicates enablement or disablement of LLI mode in a request frame, and the AP indicates whether the request is accepted or rejected.

In some embodiments, the AP accepts enablement or disablement of LLI mode without additional negotiation, such as when no parameters are exchanged/negotiated for use of LLI mode between the non-AP STA and the AP.

In some embodiments, explicit enablement by the non-AP STA is not required, and the non-AP STA may transmit the enhanced LLI signaling (as depicted in FIGS. 1A and 1B) when the AP indicates support for LLI capability (e.g., within the UHR MAC Capabilities field).

In some embodiments, enhanced LLI signaling is used not only by a non-AP STA to report urgent traffic to an AP (as depicted in FIGS. 1A and 1B), but also by the AP to report urgent traffic to a STA when the STA is a TXOP holder and the AP operates as a TXOP responder. Such a scenario may arise when the STA obtains the TXOP via a contention-based channel access mechanism (e.g., enhanced distributed channel access (EDCA)), and thus controls access to the wireless medium during the TXOP.

When a STA is the TXOP holder, the AP may be unable to directly access the channel to transmit or schedule traffic. However, the AP may have urgent low-latency traffic to be served, such as latency-sensitive UL or DL traffic associated with one or more traffic flows. In such configurations, the AP may utilize enhanced LLI signaling to inform the TXOP holder STA of the urgent traffic and request sharing of the TXOP. The enhanced LLI signaling may be conveyed in a control response frame transmitted by the AP as a TXOP responder, such as a BA frame (e.g., a multi-STA BA frame). The enhanced LLI signaling may include one or more traffic-related parameters, such as TID, AC, SCS ID, queue size, expiry time, and a requested TXOP duration.

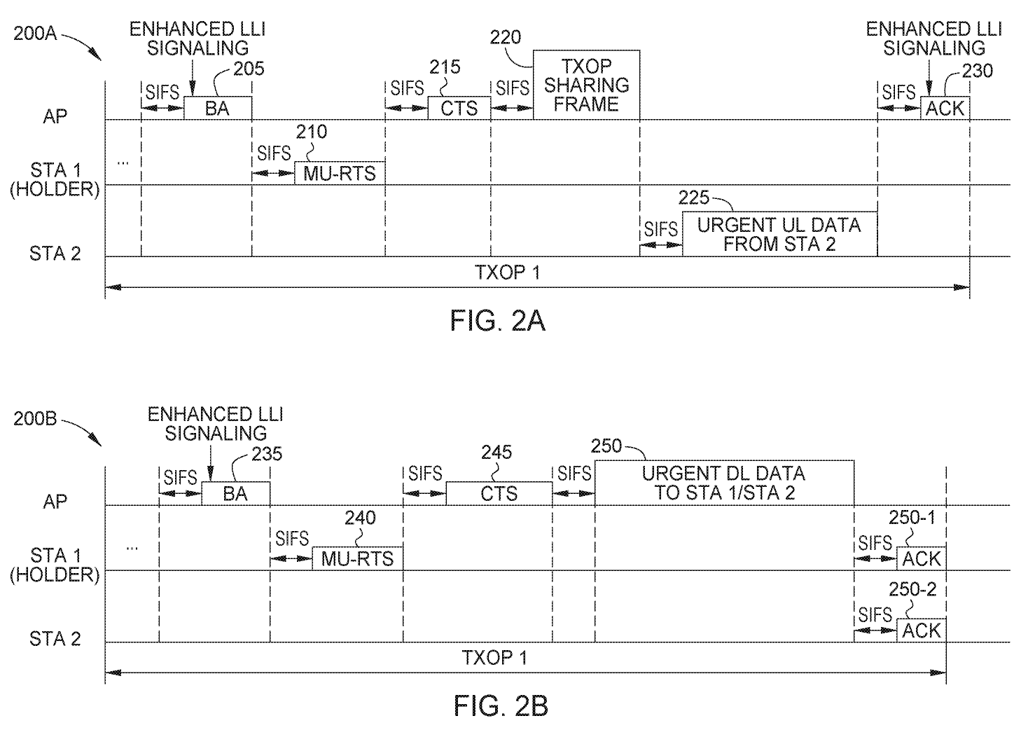

FIGS. 2A and 2B illustrate examples 200A and 200B of contention-based transmission with enhanced LLI signaling. In these examples 200A and 200B, the AP may correspond to an AP MLD, and STA 1 and STA 2 may correspond to separate STAs or different links of a STA MLD. As depicted, the STA 1 is the TXOP holder, and the AP operates as a TXOP responder.

Referring to FIG. 2A, STA 1 obtains a TXOP (e.g., TXOP 1) via contention-based access (e.g., EDCA), and transmits uplink data. The AP, acting as a TXOP responder, transmits a BA frame 205 (e.g., a Multi-STA BA frame) to acknowledge reception of the previously transmitted uplink data (not shown). Upon determining that there is urgent uplink traffic to be served from STA 2, the AP includes enhanced LLI signaling in the BA frame 205. In one example, such urgent UL traffic may correspond to periodic Stream Classification Service (SCS) traffic with a low delay bound (e.g., an extended reality (XR) flow with a delay bound on the order of a few milliseconds) for which a service interval has already begun and timely transmission is required.

In embodiments where the urgent UL traffic originates from the TXOP holder STA 1, additional LLI signaling may not be required, since STA 1 already controls the TXOP. However, when the urgent UL traffic originates from another STA (e.g., STA 2), the AP includes enhanced LLI signaling in the BA frame 205 to inform STA 1 of the urgency. The enhanced LLI signaling may include an LLI field indicating the presence of urgent traffic (e.g., a value set to 1). In some embodiments, the enhanced LLI signaling further includes an indicator of traffic direction (e.g., UL or DL). Additionally, the enhanced LLI signaling may further include one or more traffic-related parameters, such as priority information (e.g., indicated by TID/AC/SCS ID), queue size, and expiry time. In some embodiments, the AP also indicates an expected TXOP duration requested to be shared. In some embodiments, the AP explicitly requests that the non-AP STA terminate its TXOP to allow the AP to acquire the channel for serving the urgent low-latency traffic.

Upon receiving the BA frame 205 with enhanced LLI signaling, STA 1 may determine whether to share the TXOP (e.g., TXOP 1). If STA 1 agrees to share the TXOP, it may initiate a TXOP sharing procedure by transmitting a multi-user request-to-send (MU-RTS) frame 210. The AP responds with a clear-to-send (CTS) frame 215, and a TXOP sharing indication frame 220 is used to notify STA 2 to utilize the shared TXOP. Following TXOP sharing, STA 2 transmits urgent uplink data 225 within the shared TXOP after a short interframe spacing (SIFS). Upon completion of the UL transmission, the AP transmits an ACK frame 230 to acknowledge the reception of the urgent UL data 225. In some embodiments, the ACK frame 230 further includes additional LLI signaling corresponding to subsequent urgent traffic (if present).

As depicted, the urgent UL transmission is scheduled within the same TXOP (e.g., TXOP 1) if sufficient time remains and the latency constraints can be satisfied. After completion of the urgent traffic transmission, if any TXOP duration remains, the AP may return control of the remaining TXOP to STA 1 using a TXOP return mechanism. In some embodiments, STA 1 terminates the TXOP 1 early in response to the enhanced LLI signaling, so that the AP can acquire channel access in a subsequent TXOP (e.g., TXOP 2) and serve the urgent traffic.

Referring to FIG. 2B, a similar sequence is illustrated for urgent DL traffic. STA 1 is again the TXOP holder and transmits UL data (not shown) within TXOP 1. The AP, acting as a TXOP responder, transmits a BA frame 235 (e.g., a Multi-STA BA frame) acknowledging the UL transmission and includes enhanced LLI signaling indicating the presence of urgent DL traffic.

The urgent DL traffic may be transmitted to the TXOP holder STA 1 and/or another STA, such as STA 2. In some embodiments, the urgent DL traffic corresponds to event-based traffic having a latency requirement that is shorter than or comparable to the duration of the TXOP. The enhanced LLI signaling within the BA frame 235 may include an LLI field indicating the presence of urgent traffic (e.g., a value set to 1), and in some embodiments, an additional indication of traffic direction (e.g., DL). The enhanced LLI signaling may further include one or more traffic-related parameters, such as priority information (e.g., indicated by TID/AC/SCSID), queue size, and expiry time. In some embodiments, when the urgent DL traffic is intended for the TXOP holder STA 1, the enhanced LLI signaling includes an indication that the urgent traffic is targeted to the TXOP holder using a dedicated bit.

Upon receiving the enhanced LLI signaling, STA 1 may determine whether to share the TXOP. If STA 1 agrees to share the TXOP (e.g., TXOP 1), it may initiate a TXOP sharing procedure by transmitting a MU-RT frame 240. The AP may respond with a CTS frame 245 and subsequently transmit urgent DL data 250 to one or more STAs, such as STA 1 and/or STA 2. After the DL transmission, the receiving STAs may transmit acknowledgment frames, such as ACK frames 255-1 and 255-2.

Similar to the UL case, as depicted in FIG. 2B, the urgent DL transmission may occur within the same TXOP (e.g., TXOP 1) if sufficient time remains and latency requirements can be satisfied. In some embodiments, the STA 1 terminates the TXOP 1 early, allowing the AP to acquire channel access in a subsequent TXOP (e.g., TXOP 2) to serve the urgent DL traffic.

In some embodiments, upon receiving enhanced LLI signaling from the AP, the TXOP holder STA 1 determines whether to share the TXOP based on one or more decision criteria. For example, STA 1 may compare a priority associated with the urgent low-latency traffic indicated by the AP with a priority of its own traffic. In one embodiment, the priority is determined based on an AC. If the urgent traffic from the AP corresponds to an AC that is higher than or equal to the AC used by STA 1 to obtain the TXOP (e.g., TXOP 1), STA 1 may determine to share the TXOP with the AP. For example, if STA 1 obtained the TXOP 1 using a best effort access category (AC_BE) and the urgent traffic corresponds to a voice (AC_VO) or video (AC_VI) category, STA 1 may elect to share the TXOP. Conversely, if the urgent traffic corresponds to a lower priority AC than that of the ongoing transmission, STA 1 may determine to retain the TXOP.

In another embodiment, STA 1 evaluates traffic priority based on TIDs. If the urgent traffic indicated by the AP corresponds to higher priority TIDs (or equivalent priority levels) compared to the TIDs of traffic currently buffered at STA 1, STA 1 may determine to share the TXOP (e.g., the current TXOP 1). Conversely, if STA 1 has pending traffic associated with higher priority TIDs than those indicated in the LLI signaling, STA 1 may elect to continue its own transmission without sharing the TXOP.

If the enhanced LLI signaling does not include an explicit TXOP sharing request from the AP, STA 1 may determine whether to share or retain the TXOP (e.g., the current TXOP 1) based on local decision logic. For example, STA 1 may voluntarily terminate the TXOP or share a portion of the TXOP to allow the AP to serve urgent traffic, or may continue transmission if its own traffic has higher priority.

In some embodiments, STA 1 implements a Network Allocation Vector (NAV) chaining mechanism to facilitate partial TXOP sharing. For example, STA 1 may set a duration field corresponding only to a current physical layer protocol data unit (PPDU) transmission plus a small additional interval (e.g., 1 or 2 SIFS), instead of reserving the entire TXOP duration (e.g., TXOP 1). As a result, other STAs in the basic service set (BSS) (e.g., STA 2) may set their NAV based on the shorter duration, and the AP can access the medium and schedule urgent transmissions within the remaining portion of the TXOP.

In some embodiments, STA 1 also terminates the TXOP early in response to the enhanced LLI signaling. For example, STA 1 may transmit a control frame (e.g., a control frame (CF)-end frame) to indicate early termination of the TXOP (e.g., TXOP 1). The early termination enables the AP to acquire channel access and serve urgent traffic. In some embodiments, the AP explicitly requests early termination of the TXOP via the enhanced LLI signaling.

The enhanced LLI signaling depicted in FIGS. 2A and 2B as being conveyed within an initial control response (ICR) frame (e.g., a BA or a Multi-STA BA frame) is provided for conceptual clarity. In some embodiments, the AP conveys enhanced LLI signaling using other signaling formats. For example, the AP may include LLI-related information in an A-Control field of a data frame or a control frame. Additionally, the AP may convey enhanced LLI signaling in a BSRP trigger frame (e.g., within a common information field or a user-specific field). Such flexibility enables integration of enhanced LLI signaling into different frame types and transmission contexts.

In addition to enhanced LLI signaling exchanged between an AP and a non-AP STA (as depicted in FIGS. 1A-1B and 2A-2B), enhanced LLI signaling may also be exchanged between APs, such as in coordinated time division multiple access (Co-TDMA) operation. In such operations, a sharing AP may share at least a portion of its TXOP with one or more coordinated APs (e.g., co-channel APs) based on traffic requirements.

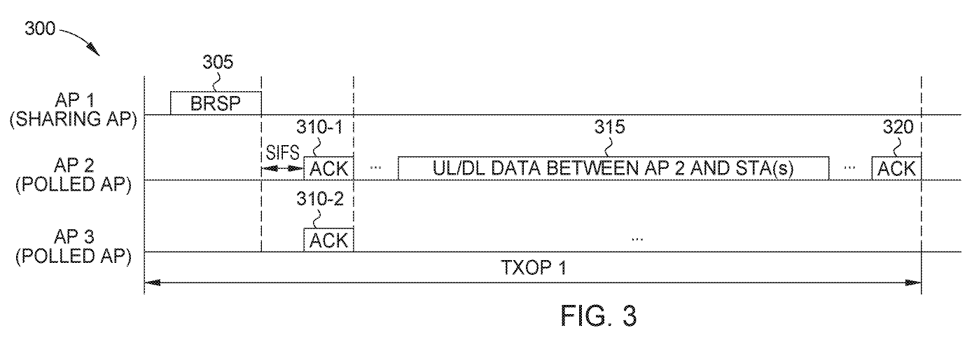

FIG. 3 depicts an example 300 of enhanced LLI signaling between APs for transmission of urgent traffic. In this embodiment, AP 1 corresponds to a sharing AP, and AP 2 and AP 3 correspond to polled APs. The Co-TDMA operation may include a polling phase, where the sharing AP polls one or more co-channel APs to determine whether the polled APs have urgent traffic requiring TXOP sharing.

As shown in FIG. 3, in one embodiment, the polling frame is an initial control frame (ICF), such as a BSRP trigger frame 305. In response, the polled AP 2 and AP 3 transmit initial control response (ICR) frames, such as ACK frames or Multi-STA BA frames 310-1 and 310-2, respectively.

A polled AP that has urgent low-latency traffic may include enhanced LLI signaling within the response frame (e.g., ACK or Multi-STA BA frame 310). The enhanced LLI signaling may indicate the presence of urgent UL/DL traffic and may include one or more traffic-related parameters, including but not limited to, priority information (e.g., indicated by AC/TID/SCS ID), a requested TXOP duration or buffer size (e.g., queue size), and an expiry time associated with the urgent traffic. In some embodiments, a polled AP reports information for multiple traffic flows (e.g., multiple ACs or TIDs). In other embodiments, the polled AP reports only the most urgent traffic flow, along with corresponding traffic-related parameters. The polled AP may also indicate an aggregated amount of TXOP duration requested to serve its urgent traffic, either for multiple traffic flows or for only the most urgent traffic flow.

As illustrated in FIG. 3, in one embodiment, only AP 2 has urgent traffic to be served and includes enhanced LLI signaling in its response frame 310-1. Upon receiving the response frames from the polled APs, AP 1 may determine whether to share or retain the TXOP (e.g., TXOP 1) based on the received LLI information. If AP 1 determines to share the TXOP, AP 2 may utilize at least a portion of the TXOP (e.g., TXOP 1) to transmit or receive urgent traffic with its associated STAs, followed by corresponding ACK frames 320.

In some embodiments, multiple polled APs (e.g., AP 2 and AP 3) both indicate urgent traffic via enhanced LLI signaling (e.g., in ACK or Multi-STA BA frames 310-1 and 310-2). In such cases, the sharing AP (AP 1) may compare the traffic-related parameters (e.g., priority, expiry time, or requested TXOP duration) and determine which AP to prioritize for TXOP sharing. The sharing AP may allocate the TXOP entirely to one AP or divide the TXOP among multiple APs based on the determined priorities and latency requirements.

FIG. 4 illustrates an example of an extended LLI feedback element 405 configured to carry enhanced traffic-related information associated with urgent low-latency traffic. The extended LLI feedback element 405 may be included in a control response frame, such as an ACK frame for DL transmission or a Multi-STA BA frame for UL transmission. In some embodiments, the extended LLI feedback element 405 is included in other initial control response (ICR) frames or control frames.

As shown in FIG. 4, the extended LLI feedback element 405 may include an Association Identifier (AID) and Traffic Identifier (TID) Information (Info) field 410 (hereinafter AID TID Info field), a Block Acknowledgment (Ack) Starting Sequence Control field 415 (hereinafter Block Ack Starting Sequence Control field), and a Feedback field 420. As depicted, the Block Ack Starting Sequence Control field 415 further includes a value indicating that LLI feedback is present (e.g., a feedback type value set to indicate LLI feedback).

As shown, the Feedback field 420 includes a Low Latency Indication Feedback subfield 425. The Low Latency Indication Feedback subfield 425 further includes one or more subfields 430-450 carrying enhanced LLI information. As illustrated, in one embodiment, the subfields includes a Low Latency Indication subfield 430, which indicates the presence of urgent low-latency traffic (e.g., a value set to 1), a Traffic Identification subfield 435, which indicates a traffic classification associated with the urgent traffic, such as a TID, AC, or SCS ID, a reserved subfield 440, a Queue Size subfield 445, which indicates a buffer size associated with the urgent traffic, and an Expiry Time subfield 450, which indicates a deadline (e.g., TSF-based time) by which the urgent traffic is to be served.

In some embodiments, the signaling overhead associated with LLI reporting is minimized (or at least reduced). For example, a non-AP STA may indicate traffic details for only a single traffic flow, such as a single traffic identifier (TID) corresponding to urgent low-latency (LL) traffic. A non-AP STA may not have urgent LL traffic across multiple TIDs simultaneously (or may select the most urgent or highest priority LL traffic), and thus the Low Latency Indication Feedback subfield 425 may include information for only one urgent traffic flow.

In other embodiments, traffic details are provided for multiple traffic flows. For example, the Low Latency Indication Feedback subfield 425 may include multiple sets of traffic-related parameters (e.g., AC, TID, SCS ID, queue size, and expiry TSF time) corresponding to urgent traffic associated with different TIDs. In one embodiment, such signaling is achieved by including multiple instances of the Low Latency Indication Feedback subfield 425, each corresponding to a different AID and/or TID and/or SCS ID. In another embodiment, to indicate multiple traffic flows, the Traffic Identification subfield 435 includes a list of traffic identifiers, such as multiple ACs, TIDs, or SCS IDs.

In some embodiments, a Link Identifier (Link ID) field is included (not shown), when a current link is not used as a reference link for the expiry TSF time. The included link ID enables the recipient (e.g., TXOP holder) to properly interpret timing information across multiple links.

In some embodiments, one or more of the subfields 435-450 are optionally included in the Low Latency Indication Feedback subfield 425 depending on availability of traffic-related parameters associated with the urgent traffic flows. For example, when only traffic classification information is available, the Traffic Identification subfield 435 is included. When both traffic classification and buffer information are available, the Traffic Identification subfield 435 and the Queue Size subfield 440 are included. When additional timing information is available, the Expiry Time subfield 445 is also included. Accordingly, the composition of the Low Latency Indication Feedback subfield 425 may be dynamically adapted based on available information. The dynamic adaptation enables efficient signaling with reduced overhead.

Before enhanced LLI signaling is used for scheduling or TXOP sharing (as depicted in FIGS. 1A-1B, 2A-2B, and 3), an LLI operating mode or policy may be negotiated between an AP and a non-AP STA (or between a TXOP holder and a TXOP responder). The LLI operating mode may be applied per TID, per AC, or per traffic flow (e.g., identified by an SCS ID). During such negotiation, the STA may propose one or more traffic-related parameters for requested traffic flows, and the AP may determine whether to allow use of the LLI operating mode for the STA and corresponding traffic flows. The AP may accept, reject, or modify the requested parameters based on its policy and network conditions.

In some embodiments, negotiation of the LLI operating mode and associated parameters is performed using an SCS Request/Response exchange. In other embodiments, the negotiation is performed using an ultra-high reliability (UHR) operating mode control framework. Additionally, such negotiation may be performed during an association or re-association procedure (e.g., via (Re)Association Request/Response frames that include LLI-related information elements). In one embodiment, a Low Latency Indication element (e.g., 405 in FIG. 4) is defined to carry parameters associated with the requested LLI operating mode, such as traffic classification (e.g., indicated by AC/TID/SCS ID), delay constraints (e.g., queue size or expiry time), and other traffic-related parameters.

FIG. 5 illustrates an example signaling exchange 500 between an AP MLD 505 and a STA MLD 510 for negotiation and termination of an LLI operating mode. In this example 500, the AP MLD 505 may correspond to a TXOP holder, and the STA MLD 510 may correspond to a TXOP responder. In some embodiments, similar negotiation and termination procedures are applied in other scenarios, such as between coordinated APs in a Co-TDMA operation for TXOP sharing, or between an AP and a STA when the STA is a TXOP holder and the AP initiates negotiation.

The negotiation phase begins with transmission of a request message 515 from the STA MLD 510 to the AP MLD 505. In one embodiment, the request message 515 corresponds to an SCS Request frame, a (Re)Association Request frame, or a Link Reconfiguration Request frame. In some embodiments, the request message 515 corresponds to frames exchanged before association, such as a probe request frame or beacon. The request message 515 may include an indication that LLI operating mode is requested. For example, when the request message 515 corresponds to an SCS Request frame, the STA MLD 510 may set an LLI Requested field to indicate a request for LLI operation (e.g., set to 1), and a Direction field included in a QoS Characteristics element may be set to indicate uplink traffic. In some embodiments, when the Direction field indicates downlink or direct link traffic, the LLI Requested field is reserved.

In the requested message 515, the STA MLD 510 may include one or more parameters associated with the requested LLI operating mode. For example, the STA MLD 510 may indicate one or more ACs or TIDs for which LLI mode is requested. When the LLI operating mode is applied at an SCS stream level, the STA MLD 510 may identify one or more traffic flows using traffic classification (TCLAS), SCS IDs, application identifiers (App IDs), or fully qualified domain names (FQDNs). The information allows the AP MLD 505 to determine the corresponding application or IP flows associated with the request.

The STA 510 may further include one or more traffic-related parameters, such as a delay bound (e.g., 10 ms), an expiry time threshold (e.g., within 10 ms), and a minimum data rate. In some embodiments, when negotiation is performed at an SCS stream level and the LLI Requested field is set to indicate a request for LLI operation (e.g., set to 1), the STA 510 may provide a delay bound value for the SCS stream that is not set to an unspecified value (e.g., not equal to zero), and may also include a minimum data rate parameter. In some embodiments, the AP 505 may require the STA 510 to provide uplink traffic classification information (e.g., TCLAS) for a requested SCS stream in order to evaluate whether to allow LLI operation based on policy.

In some embodiments, the STA MLD 510 specifies requirements for event-based or aperiodic traffic flows by setting Minimum and Maximum Service Interval fields to unspecified values (e.g., minimum or maximum interval values). The request message may further include one or more of a delay bound or a minimum data rate. In other embodiments, the Minimum and Maximum Service Interval fields are not included when UL triggering is not required for the corresponding SCS stream.

Upon receiving the request message 515, the AP MLD 505 evaluates whether to allow use of the LLI operating mode based on the requested parameters and one or more policies of the AP. The AP MLD 505 may respond with one of several response messages, such as 520-1, 520-2, or 520-3, using an SCS Response frame, a (Re)Association Response frame, or a Link Reconfiguration Response frame.

In a first case, the AP MLD 505 accepts the request. The response message 520-1 includes a status code (e.g., an “ACCEPTED_LLI_MODE_ALLOWED”), indicating that the requested SCS stream is accepted and that use of the LLI operating mode is allowed for the corresponding traffic flow. In such a configuration, the AP MLD 505 omits a QoS Characteristics element in the response 520-1 since the requested parameters are accepted without modification.

In a second case, the AP MLD 505 rejects the request. The response message 520-2 includes a rejection status code (e.g., “REJECTED_LLI_MODE_NOT_ALLOWED”), indicating that use of the LLI operating mode is not permitted for the requested traffic flow. Such rejection may be based on the AP MLD’s policy. For example, the STA may request LLI operation for a low-priority access category (e.g., AC_BK), which is not supported for LLI usage by the AP.

In a third case, the AP MLD 505 rejects the request but provides suggested modifications to the requested parameters. The response message 520-3 may include a status code (e.g., “REJECTED_WITH_SUGGESTED_CHANGES”) indicating rejection with suggested changes. The response message 520-3 may further include a modified set of QoS Characteristics parameters. For example, the AP may suggest modified delay bounds, minimum data rates, or service interval parameters. In some embodiments, the response 520-3 includes an updated LLI Requested indication (e.g., set to 0 or 1), along with other modified parameters, indicating conditions under which the AP would accept the request. Upon receiving such a response 520-3, the STA MLD 510 may transmit a subsequent request message with revised parameters in accordance with the suggested changes.

In some embodiments, the AP MLD 505 requests use of LLI operating mode even if the STA MLD 510 did not initially request it. For example, if the STA MLD 510 transmits an SCS request without setting the LLI Requested field, the AP may reject the request and include a suggested QoS Characteristics element indicating that the STA should enable LLI operation (e.g., LLI Requested = 1) for the corresponding SCS stream. This may occur when the AP seeks to prioritize UL traffic for latency-sensitive applications. In response, the STA may transmit a follow-up SCS request including the requested parameters with the LLI Requested field set accordingly.

As mentioned above, in some embodiments, the SCS Request/Response exchange is used to negotiate use of the LLI operating mode at a TID level or AC level. In such configurations, the STA MLD 510 may transmit an SCS Request 515 including one or more QoS Characteristics (QC) elements, each indicating a respective TID or AC for which use of LLI operating mode is requested (e.g., with an LLI Requested field set to 1). In one embodiment, each QC element further includes traffic characteristics associated with the corresponding TID or AC, such as a delay bound or a minimum data rate. Multiple QC elements may be included in a single SCS Request to request LLI operation for multiple TIDs or ACs.

Upon receiving the SCS Request 515, the AP 505 may determine whether to allow use of LLI operating mode for one or more of the requested TIDs or ACs based on its policy and network conditions. The AP may accept or reject the request on a per-TID basis. In the embodiment of rejection, the AP includes a counterproposal in the SCS Response 520-3 by providing one or more QC information elements indicating a set of TIDs or ACs for which LLI operation is permitted. The STA may then transmit a follow-up SCS Request frame including the suggested set of TIDs with the LLI Requested field set accordingly.

Following successful negotiation, use of the negotiated LLI operating mode or policy may be enabled for one or more traffic entities. For example, the negotiation may allow usage of LLI operating mode for one or more SCS streams, which may map to one or more TIDs as indicated by corresponding QC elements. In TID-based negotiation, usage of LLI operating mode may be allowed for traffic associated with one or more specific TIDs or ACs.

After negotiation, the AP 505 may continue to verify compliance of the STA 510 with the negotiated LLI operating mode by monitoring enhanced LLI signaling transmitted by the STA, such as in an ICR frame (e.g., ACK frames, BA frames, or Multi-STA BA frame) used to request TXOP sharing. For example, when the STA transmits UL traffic following LLI signaling, the AP may determine whether the traffic corresponds to one or more TIDs or SCS streams for which LLI usage was authorized during negotiation. If the transmitted traffic conforms to the negotiated parameters, the AP 505 may approve the request and schedule transmission resources for the urgent traffic. Conversely, if the STA transmits traffic associated with TIDs or flows outside the negotiated scope, the STA may be considered non-compliant, and the AP may decline to allocate resources for such traffic.

In some embodiments, upon detecting repeated or significant violations of the negotiated LLI operating mode, the AP 505 can take enforcement actions. As illustrated in FIG. 5, such actions may include transmitting a termination message 525 to the STA. In one embodiment, the termination message 525 corresponds to an unsolicited SCS Response frame indicating termination of one or more TIDs, ACs, or SCS streams for which the LLI Requested field was previously set to 1. The termination message 525 may further include a suggested QC element indicating that the LLI Requested field should be set to 0 for one or more SCS streams, TIDs, or ACs. If the STA 510 no longer has any UL traffic (e.g., identified by SCS IDs, ACs, or TIDs) configured with the LLI Requested field set to 1, the STA may disable LLI operation and refrain from transmitting LLI signaling (e.g., in Multi-STA BA frames) to the AP 505.

If the STA 510 continues to transmit LLI signaling despite termination of the LLI operating mode, the AP 505 may take additional actions, such as reducing the number of established links for the STA 510 (e.g., via a BSS Transition Management (BTM) Request suggesting a reduced number of links) or disassociating the STA from the network.

In some embodiments, the AP 505 terminates or modifies the negotiated LLI operating mode or associated policies for specific TIDs, ACs, or SCS streams in response to changing network conditions or policy updates. For example, for event-based or aperiodic traffic flows, the AP 505 may terminate the corresponding SCS streams by transmitting an unsolicited SCS Response frame 525 indicating that the LLI Requested field is set to 0. For periodic traffic flows associated with defined service intervals (e.g., values within the Minimum and Maximum Service Interval fields), the AP 505 may either terminate the SCS streams by transmitting the unsolicited SCS Response frame 525 or by sending an SCS change message with the LLI Requested field set to 0 in its QC element.

The negotiation of LLI operating mode may be performed prior to or after association, and may apply to both trigger-based TXOPs (where the AP 505 schedules transmissions) and contention-based TXOPs (where the STA 510 can acquire channel access via contention). Following negotiation, the AP 505 and/or the STA 510 may monitor signaling and transmissions to verify compliance with the negotiated LLI operating mode and associated parameters.

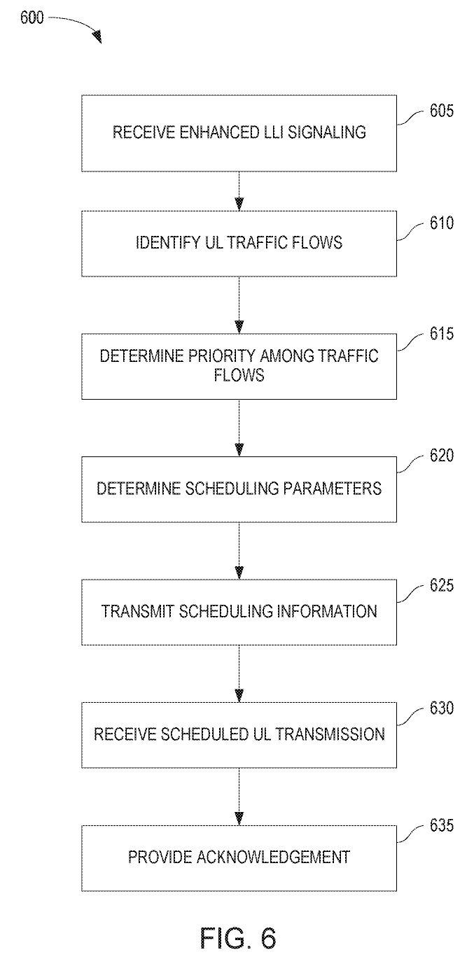

FIG. 6 depicts an example method 600 performed by an AP for scheduling urgent UL traffic based on enhanced LLI signaling. The AP may correspond to the AP depicted in FIGS. 1A-1B.

At block 605, the AP receives enhanced LLI signaling from one or more non-AP STAs (e.g., STA 1 or STA 2 in FIGS. 1A-1B). In some embodiments, the enhanced LLI signaling is carried within a low latency indication feedback element (e.g., extended LLI feedback element 405 in FIG. 4). The enhanced LLI signaling may be included in a control response frame, such as piggybacked in a BSR (e.g., 110 in FIG. 1A), a Multi-STA BA frame (e.g., 125 in FIG. 1A) corresponding to a previous UL transmission (e.g., 120 in FIG. 1A), or an ACK frame (e.g., 150 in FIG. 1B) corresponding to a previous DL transmission (e.g., 145 in FIG. 1B). The enhanced LLI signaling may also be conveyed in other control frames or signaling formats. The enhanced LLI signaling may include an indication of urgent traffic (e.g., a low latency indicator within the LLI subfield 430 in FIG. 4) and one or more traffic-related parameters associated with the urgent traffic, such as a TID, an AC, an SCS ID, a queue size, and an expiry time.

At block 610, the AP identifies one or more traffic flows for scheduling consideration. The identified traffic flows may include urgent UL traffic flows indicated by one or more STAs via enhanced LLI signaling. For example, the urgent UL traffic flows may originate from STA 1, STA 2, or both, as depicted in FIGS. 1A-1B. The identified traffic flows may further include traffic flows (either UL or DL) already maintained in transmission queues (e.g., organized per TID or AC) or scheduling contexts of the AP. In some embodiments, identification of the UL traffic flows is based on one or more traffic-related parameters included in the enhanced LLI signaling, such as priority information (including TID, AC, or SCS ID), queue size, and/or expiry time. Based on such information, the AP may associate the indicated urgent traffic with corresponding traffic flows, traffic classes, or scheduling entities for subsequent prioritization and scheduling.

At block 615, the AP determines a priority among the identified traffic flows. Specifically, the AP may determine whether to schedule urgent UL traffic indicated via enhanced LLI signaling over other traffic flows already maintained in transmission queues or scheduling contexts of the AP (including both UL and DL traffic). In some embodiments, when multiple STAs indicate urgent UL traffic, the AP further compares the urgent traffic flows to determine a relative priority and select which traffic to schedule first. The priority may be determined based on the one or more traffic-related parameters, such as the TID/AC/SCS ID indicating a type or class of the traffic, the queue size associated with each traffic flow, the expiry time indicating a latency constraint, or a combination thereof. For example, traffic flows associated with higher priority TIDs (e.g., TID 6 or 7) or earlier expiry times (e.g., less than 2 ms) may be prioritized over lower priority or less time-sensitive traffic. Based on such a comparison, the AP may rank or order the traffic flows for subsequent scheduling.

At block 620, the AP determines one or more scheduling parameters for the urgent uplink (UL) traffic based on the determined priority. The scheduling parameters may include transmission timing and, in some embodiments, resource allocation (e.g., RU assignment) when OFDMA is available. The AP may determine whether to schedule the urgent UL traffic within a current TXOP or defer transmission to one or more subsequent TXOPs. For example, when the current TXOP has sufficient remaining resources and the expiry time associated with the urgent UL traffic indicates a stringent latency requirement, the AP may assign resources and schedule the urgent UL traffic within the current TXOP (e.g., TXOP 1 in FIGS. 1A-1B). In contrast, when the remaining duration or resources of the current TXOP are insufficient, or when the urgency of the traffic is lower, the AP may defer scheduling to a subsequent TXOP (e.g., TXOP 2 in FIGS. 1A-1B) and assign corresponding transmission timing and resources.

In some embodiments, when multiple STAs indicate urgent UL traffic, the AP determines scheduling parameters across the multiple STAs, including selecting which urgent traffic is to be scheduled first and which traffic may be deferred. The AP may consider the relative priority among the urgent traffic flows as well as existing traffic already maintained in the transmission queue or scheduling context of the AP.

At block 625, the AP transmits scheduling information to one or more requesting STAs (e.g., STA 1 or STA 2 in FIGS. 1A-1B) based on the determined scheduling parameters. In some embodiments, the scheduling information is conveyed via a control frame that indicates resource allocation (e.g., RUs) and/or transmission timing. In some embodiments, the AP directly transmits a TF (e.g., 130 in FIG. 1A or 155 in FIG. 1B) to indicate when the STA is to initiate urgent UL transmission. The TF allows the STA (e.g., STA 1 in FIGS. 1A-1B) to transmit in accordance with the assigned resources and timing.

At block 630, the AP receives the scheduled UL transmission (e.g., 135 in FIG. 1A or 160 in FIG. 1B) from the one or more STAs based on the transmitted scheduling information.

At block 635, the AP transmits an ACK frame (e.g., 140 in FIG. 1A or 165 in FIG. 1B) to the respective STAs to confirm reception of the UL data. In some embodiments, the ACK is conveyed via a Multi-STA BA frame.

In some embodiments, after transmission of the scheduled UL data, a STA may have additional urgent UL traffic to be transmitted. In such configurations, the STA may transmit enhanced LLI signaling to the AP to indicate the additional urgent traffic. For example, the enhanced LLI signaling may be included in a control response frame, such as a Multi-STA BA frame or a BSR, so that dynamic scheduling of urgent traffic is continued.

The example method 600 is applied in a trigger-based access mechanism, where the AP operates as a TXOP holder and schedules UL transmissions for one or more STAs. In such embodiments, the urgent traffic corresponds to UL traffic indicated via enhanced LLI signaling, and the AP performs prioritization and scheduling as described above. In other embodiments, when the urgent traffic corresponds to DL traffic, the AP similarly determines priority among the urgent DL traffic and other DL traffic already buffered in the transmission queue (as depicted at block 615), and determines corresponding scheduling parameters (as depicted at block 620). For example, when urgent DL traffic is associated with multiple STAs, the AP may compare the traffic flows based on one or more parameters (e.g., TID, AC, SCS ID, queue size, or expiry time) to determine an order of transmission and allocate resources accordingly relative to other scheduled traffic.

In another embodiment, the operations described with respect to blocks 615-620 are applied in contention-based access scenarios, where a STA (e.g., STA 1 in FIGS. 2A-2B) is a TXOP holder. In such configurations, the AP may transmit enhanced LLI signaling via a control frame, such as a Multi-STA BA frame (e.g., 205 in FIG. 2A or 235 in FIG. 2B), to indicate urgent UL or DL traffic. Based on the received LLI signaling, the TXOP holder STA (e.g., STA 1 in FIGS. 2A-2B) may determine priority among traffic flows by considering one or more traffic-related parameters, and initiate transmission of scheduling information via an RTS (e.g., 210 in FIG. 2A or 240 in FIG. 2B) or similar control signaling to facilitate transmission of the urgent traffic.

In some embodiments, the operations described with respect to blocks 615 and 620 are applied in Co-TDMA scenarios. For example, one or more polled APs (e.g., AP 2 or AP 3 in FIG. 3) may transmit enhanced LLI signaling indicating urgent UL or DL traffic to a sharing AP (e.g., AP 1 in FIG. 1). The sharing AP may then determine priority among the traffic flows indicated by the polled APs and determine corresponding scheduling parameters, including whether to share a portion of a TXOP and how to allocate transmission resources among the coordinated APs.

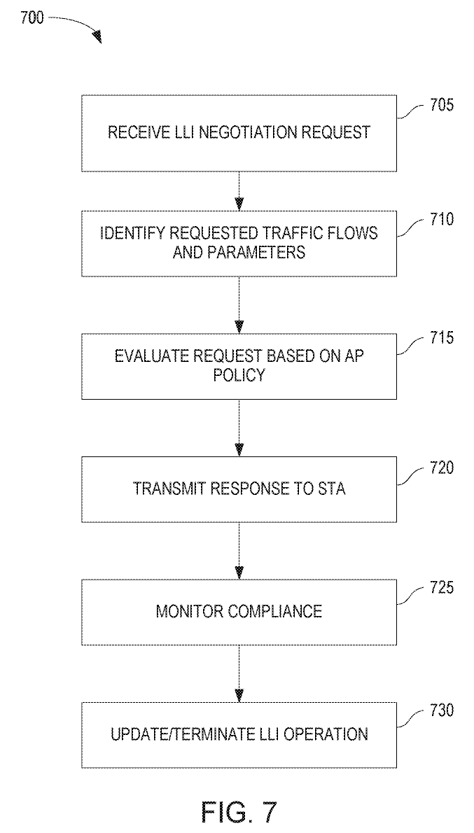

FIG. 7 depicts an example method 700 performed by an AP for negotiation of an LLI operating mode. The AP may correspond to the AP MLD 505 described with respect to FIG. 5. Each block represents an operation performed by the AP in connection with receiving a request for LLI operation, evaluating the request, and responding to a non-AP STA.

At block 705, the AP (e.g., AP MLD 505 in FIG. 5) receives a request message (e.g., 515 in FIG. 5) from a non-AP STA (e.g., STA MLD 510 in FIG. 5) associated with negotiation of the LLI operating mode. In some embodiments, the request message is received during an association or re-association procedure, such as in a (Re)Association Request frame or a Link Reconfiguration Request frame. In other embodiments, the request message is received after association, such as in an SCS Request frame. In some embodiments, the request message is conveyed in a management frame or control frame configured to carry LLI-related information, such as a probe request frame or beacon. The request message may include an indication that LLI operation is requested (e.g., an LLI Requested field set to 1) and one or more quality-of-service (QoS) parameters associated with one or more traffic flows.

At block 710, the AP identifies one or more traffic flows and corresponding QoS characteristics for which use of the LLI operating mode is requested. In some embodiments, the AP parses one or more QC elements included in the request message to determine the scope of the request. For example, the AP may identify traffic flows based on TIDs, ACs, or SCS IDs, and may further determine associated QoS characteristics, such as delay bound, minimum data rate, service interval parameters (e.g., minimum or maximum service intervals), or traffic classification information (e.g., TCLAS, App ID, or FQDN). In embodiments where multiple QC elements are included, the AP may identify multiple traffic flows for which LLI operation is requested on a per-TID or per-SCS stream basis.

At block 715, the AP evaluates the request based on one or more AP policies and determines whether to allow use of the LLI operating mode for the requested traffic flows. In some embodiments, the AP evaluates the requested QoS characteristics and corresponding traffic flows identified at block 710 against predefined policy criteria. For example, the AP may allow use of LLI operating mode only for traffic associated with a selected set of ACs or TIDs, or for traffic flows corresponding to established SCS streams. In some embodiments, the AP further requires that a delay bound associated with the requested traffic does not exceed an AP-defined threshold (e.g., on the order of a few milliseconds), and/or that an expiry time constraint satisfies a threshold condition. Additionally, the AP may restrict use of LLI operating mode to traffic flows associated with particular classifications, such as those identified by TCLAS, SCS IDs, App IDs, or FQDNs. Based on such policy evaluation, the AP may determine whether to accept the request, reject the request, or reject the request with suggested modifications on a per-flow, per-TID, or per-SCS basis.

At block 720, the AP transmits a response message (e.g., 520-1, 520-2, or 520-3 in FIG. 5) to the STA based on the determination at block 715. For example, the AP may generate a status code indicating that the request is accepted and that use of the LLI operating mode is allowed (e.g., “ACCEPTED_LLI_MODE_ALLOWED”), a status code indicating that the request is rejected (e.g., “REJECTED_LLI_MODE_NOT_ALLOWED”), or a status code indicating rejection with suggested changes (e.g., “REJECTED_WITH_SUGGESTED_CHANGES”). In some embodiments, the response message may be conveyed via a management or control frame, such as a (Re)Association Response frame, a Link Reconfiguration Response frame, an SCS Response frame, or a probe response frame. In embodiments where the request is rejected with suggested changes, the response may further include one or more modified QoS characteristics, such as revised delay bound, minimum data rate, service interval parameters, or a modified set of traffic identifiers (e.g., TIDs/ACs/SCS IDs) for which LLI operation is permitted. Such information enables the STA to adjust its request and perform a subsequent negotiation if desired.

At block 725, the AP monitors subsequent signaling and transmissions from the STA to verify compliance with the negotiated LLI operating mode. In some embodiments, the AP evaluates enhanced LLI signaling transmitted by the STA (e.g., in control response frames) to determine whether the indicated traffic conforms to the negotiated scope, such as the permitted traffic flows, TIDs, ACs, or SCS streams. The AP may further determine whether the associated parameters of the indicated traffic are consistent with the negotiated QoS characteristics. If the enhanced LLI signaling and corresponding traffic comply with the negotiated LLI operating mode, the AP continues to honor the LLI requests and schedule resources accordingly.

At block 730, the AP updates or terminates the LLI operating mode for one or more traffic flows based on the monitoring result, policy changes, or network conditions. In some embodiments, when non-compliance is detected, or when continued use of LLI operating mode is no longer permitted, the AP transmits a termination or modification message (e.g., 525 in FIG. 5) to the STA via an unsolicited SCS Response, indicating that LLI operation is to be disabled or modified (e.g., by setting an LLI Requested field to 0 for one or more TIDs, ACs, or SCS streams). In some embodiments, the AP further restricts or disallows LLI operation upon repeated violations or adjusts the configuration associated with the STA.

In some embodiments, the negotiation method 700 applies in scenarios where enhanced LLI signaling is exchanged between coordinated APs or between an AP and a STA acting as a TXOP holder. For example, in Co-TDMA scenarios (as illustrated in FIG. 3), enhanced LLI signaling is exchanged between sharing and polled APs, and similar negotiation principles may be applied to determine whether LLI-based prioritization and TXOP sharing are permitted for one or more traffic flows. Similarly, in contention-based access scenarios (as illustrated in FIGS. 2A and 2B), where a STA operates as a TXOP holder and the AP acts as a responder, the AP transmits enhanced LLI signaling to the STA to request prioritization of urgent uplink or downlink traffic. In such configurations, the negotiation of LLI operating mode and associated parameters may be applied to enable the receiving entity (e.g., another AP or the TXOP holder STA) to determine whether to honor the LLI signaling based on negotiated policies or agreed operating conditions.

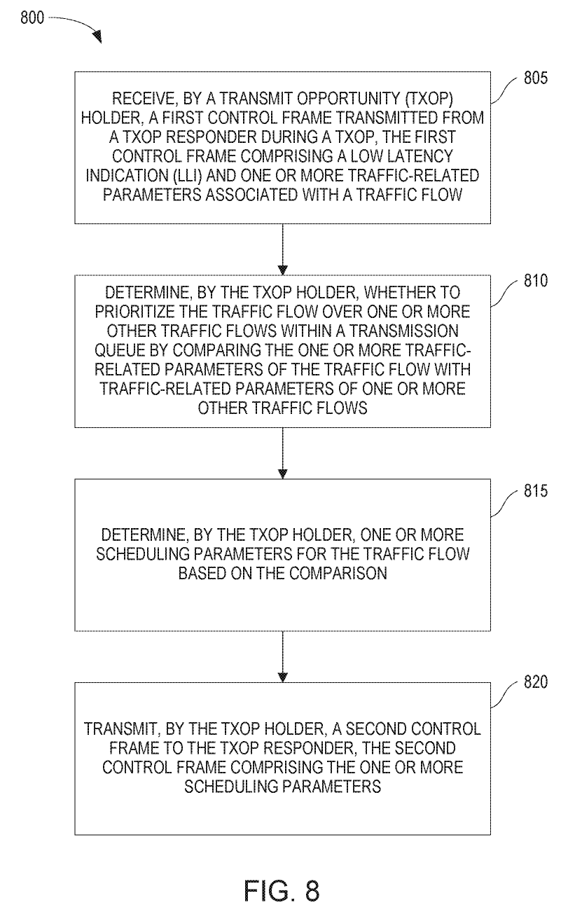

FIG. 8 is a block diagram depicting an example LLI signaling method 800, according to some embodiments of the present disclosure.

At block 805, a transmit opportunity (TXOP) holder (e.g., AP in FIGS. 1A and 1B, STA 1 in FIGS. 2A and 2B, or AP 1 in FIG. 3) receives a first control frame transmitted from a TXOP responder (e.g., STA 1 in FIGS. 1A and 1B, AP in FIGS. 2A and 2B, or AP 2 in FIG. 3) during a TXOP, the first control frame (e.g., BSR 110-1 or BA 125 in FIGS. 1A, ACK 150-1 in FIG. 1B, BA 205 in FIG. 2A, BA 235 in FIG. 2B, or ACK 310 in FIG. 3) comprising a low latency indication (LLI) and one or more traffic-related parameters associated with a traffic flow.

At block 810, the TXOP holder determines whether to prioritize the traffic flow over one or more other traffic flows within a transmission queue by comparing the one or more traffic-related parameters of the traffic flow with traffic-related parameters of one or more other traffic flows.

At block 815, the TXOP holder determines one or more scheduling parameters (e.g., transmission timing or RU assignments) for the traffic flow based on the comparison.

At block 820, the TXOP holder transmits a second control frame (e.g., TF 130 in FIG. 1A, TF 155 in FIG. 1B, MU-RTS 210 or TXOP sharing frame 220 in FIG. 2A, or MU-RTS 240 in FIG. 2B) to the TXOP responder, the second control frame comprising the one or more scheduling parameters.

In some embodiments, the traffic flow corresponds to an uplink traffic flow or a downlink traffic flow.

In some embodiments, the TXOP holder comprises an access point (AP) (e.g., AP in FIGS. 1A and 1B), and the TXOP responder comprises a non-AP station (STA) (e.g., STA 1 in FIGS. 1A and 1B).

In some embodiments, the TXOP holder comprises a non-AP station (STA) (e.g., STA 1 in FIGS. 2A and 2B), and the TXOP responder comprises an access point (AP) (e.g., AP in FIGS. 2A and 2B).

In some embodiments, the TXOP holder comprises a first access point (AP) (e.g., AP 1 in FIG. 3), and the TXOP responder comprises a second AP (e.g., AP 2 in FIG. 3), and where the first AP and the second AP operate in a coordinated time division multiple access (Co-TDMA) mode.

In some embodiments, the one or more traffic-related parameters comprise at least one of a traffic identifier (TID), an access category (AC), a stream classification service identifier (SCS ID), a buffer size, or an expiry time.

In some embodiments, the one or more scheduling parameters comprise at least one of a resource unit assignment or a transmission timing.

In some embodiments, the one or more other traffic flows are associated with a transmission queue and correspond to traffic flows between the TXOP holder and the TXOP responder or traffic flows between the TXOP holder and one or more other TXOP responders.

In some embodiments, the first control frame comprises a multi-STA block acknowledgement (BA) frame, an acknowledgement (ACK) frame, or a buffer status report (BSR) frame.

In some embodiments, the second control frame comprises a trigger frame (TF) or a request-to-send (RTS) frame.

In some embodiments, the operation of determining whether to prioritize the traffic flow comprises prioritizing the traffic flow over the one or more other traffic flows within the transmission queue based on a traffic identifier (TID) of the traffic flow being associated with a higher priority than TIDs of the one or more other traffic flows.

In some embodiments, the operation of determining whether to prioritize the traffic flow comprises prioritizing the traffic flow over the one or more other traffic flows within a transmission queue based on an expiry time of the traffic flow being earlier than expiry times of the one or more other traffic flows.

In some embodiments, in response to determining that an expiry time of the traffic flow satisfies a threshold condition, the TXOP holder schedules the traffic within the TXOP (e.g., TXOP 1 in FIGS. 1A and 1B), or in response to determining that an expiry time of the traffic flow does not satisfy a threshold condition, the TXOP holder schedules the traffic within one or more subsequent TXOPs (e.g., TXOP 2 in FIGS. 1A and 1B).

In some embodiments, the TXOP responder, upon receiving the second control frame, is configured to conduct transmission of the traffic flow following the one or more scheduling parameters.

In some embodiments, the LLI and one or more traffic-related parameters associated with the traffic flow are carried within an LLI feedback element (e.g., 405 in FIG. 4) of the first control frame.

In some embodiments, the LLI feedback element comprises an LLI field (e.g., 430 in FIG. 4) carrying the LLI, and one or more additional fields (e.g., 435-450 in FIG. 4) carrying the one or more traffic-related parameters, the one or more additional fields comprising at least one of a traffic identifier (TID) field, an access category (AC) field, a stream classification service identifier (SCS ID) field, a queue size subfield, or an expiry time field.

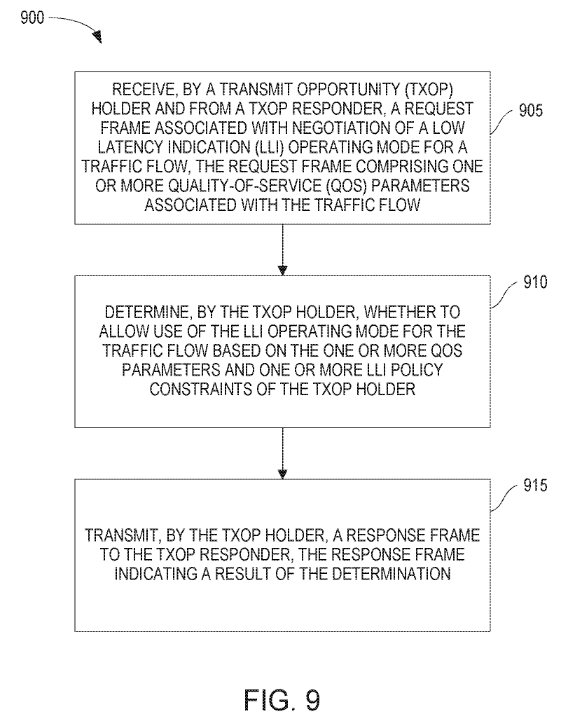

FIG. 9 is a block diagram depicting an example LLI negotiation method 900, according to some embodiments of the present disclosure.

At block 905, a transmit opportunity (TXOP) holder (e.g., AP MLD 505 in FIG. 5) receives, from a TXOP responder (e.g., STA MLD 510 in FIG. 5), a request frame (e.g., 515 in FIG. 5) associated with negotiation of a low latency indication (LLI) operating mode for a traffic flow, the request frame comprising one or more quality-of-service (QoS) parameters associated with the traffic flow.

At block 910, the TXOP holder determines whether to allow use of the LLI operating mode for the traffic flow based on the one or more QoS parameters and one or more LLI policy constraints of the TXOP holder.

At block 915, the TXOP holder transmits a response frame (e.g., 520-1, 520-2, or 520-3 in FIG. 5) to the TXOP responder, the response frame indicating a result of the determination.

In some embodiments, the TXOP holder comprises an access point (AP), and the TXOP responder comprises a non-AP station (STA).

In some embodiments, the TXOP holder comprises a non-AP station (STA), and the TXOP responder comprises an access point (AP).

In some embodiments, the TXOP holder comprises a first access point (AP), and the TXOP responder comprises a second AP, and where the first AP and the second AP operate in a coordinated time division multiple access (Co-TDMA) mode.

In some embodiments, the request frame comprises at least one of a stream classification service (SCS) request frame, a probe request frame, an association request frame, a reassociation request frame, or a link reconfiguration request frame.

In some embodiments, the request frame comprises a field (e.g., LLI Requested field) indicating a request to use the LLI operating mode for the traffic flow.

In some embodiments, the one or more QoS parameters comprise at least one of a traffic identifier (TID), an access category (AC), a stream classification service identifier (SCS ID), a delay bound, a minimum data rate, a minimum service interval, a maximum service interval, an application identifier (App ID), or a fully qualified domain name (FQDN).

In some embodiments, the traffic flow corresponds to an uplink traffic flow or a downlink traffic flow.

In some embodiments, the response frame comprises at least one of a rejection status code (e.g., “REJECTED_LLI_MODE_NOT_ALLOWED”) indicating that use of the LLI operating mode for the traffic flow is not allowed, an acceptance status code (e.g., “ACCEPTED_LLI_MODE_ALLOWED”) indicating that use of the LLI operating mode for the traffic flow is allowed, or a rejection with suggestion status code (e.g., “REJECTED_WITH_SUGGESTED_CHANGES”) indicating that use of the LLI operating mode for the traffic flow is conditionally allowed based on one or more modified operating-related parameters.

In some embodiments, the TXOP holder transmits, to the TXOP responder, a second response frame (e.g., 525 in FIG. 5) to modify or terminate use of the LLI operating mode for the traffic flow.

In some embodiments, the response frame comprises at least one of a stream classification service (SCS) response frame, a probe response frame, an association response frame, a reassociation response frame, or a link reconfiguration response frame.

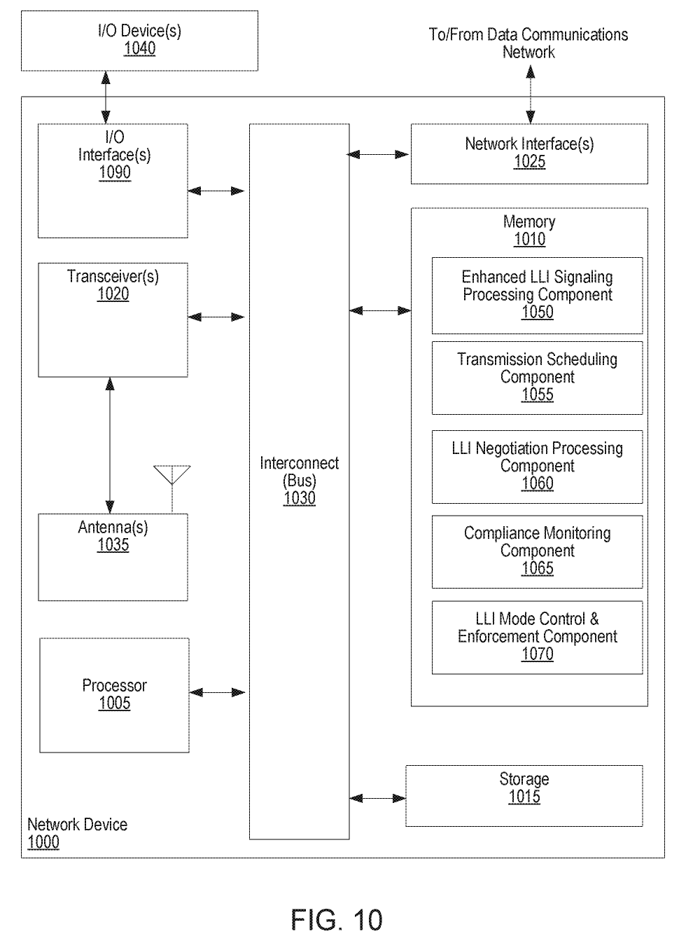

FIG. 10 depicts an example network device 1000 configured to perform various aspects of the present disclosure, according to some embodiments of the present disclosure. The example network device 1000 may correspond to a TXOP holder, such as the AP as depicted in FIGS. 1A and 1B, the STA 1 as depicted in FIGS. 2A and 2B, or the AP 1 as depicted in FIG. 3.

As illustrated, the network device 1000 includes a processor 1005, memory 1010, storage 1015, one or more transceivers 1020, one or more I/O interfaces 1090, and one or more network interfaces 1025. In some embodiments, I/O devices 1040 are connected via the I/O interface(s) 1090. Further, via the network interface 1025, the network device 1000 can be communicatively coupled with one or more other devices and components (e.g., via a network, which may include the Internet, local network(s), and the like). Each of the components is communicatively coupled by one or more buses 1030. In some embodiments, one or more antennas 1035 may be coupled to the transceivers 1020 for transmitting and receiving wireless signals.

The processor 1005 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1005 processes information received through the transceivers 1020, I/O interfaces 1090, and the network interfaces 1025. The processor 1005 retrieves and executes programming instructions stored in memory 1010, as well as stores and retrieves application data residing in storage 1015.

The storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1015 may store a variety of data for the efficient functioning of the system.

The memory 1010 may include random access memory (RAM) and read-only memory (ROM). The memory 1010 may store processor-executable software code containing instructions that, when executed by the processor 1005, enable the network device 1000 to perform various functions described herein for wireless communication.

As depicted, the memory 1010 includes an enhanced LLI signaling processing component 1050, a transmission scheduling component 1055, an LLI negotiation processing component 1060, a compliance monitoring component 1065, and an LLI model control and enforcement component 1070.

In one embodiment, the enhanced LLI signaling processing component 1050 is configured to process enhanced LLI signaling received from one or more devices. More specifically, the enhanced LLI signaling processing component 1050 parses control frames or management frames carrying LLI signaling, extracts one or more traffic-related parameters (e.g., priority information, expiry time, or queue size) associated with indicated traffic flows, and determines whether urgent traffic is present. The enhanced LLI signaling processing component 1050 further generates responses that include scheduling parameters and transmits the responses to the requesting devices.

In one embodiment, the transmission scheduling component 1055 is configured to determine scheduling of traffic flows based on priority. More specifically, the transmission scheduling component 1055 determines priority among one or more traffic flows, compares associated parameters, and determines one or more scheduling parameters for the traffic flows. The scheduling parameters may include transmission timing, resource allocation, or whether a traffic flow is to be scheduled within a current TXOP or deferred to one or more subsequent TXOPs.

In one embodiment, the LLI negotiation processing component 1060 is configured to process requests for negotiation of an LLI operating mode. More specifically, the LLI negotiation processing component 1060 receives a request message (e.g., 515 in FIG. 5) from a non-AP STA, identifies one or more requested traffic flows and associated QoS characteristics, and evaluates whether use of the LLI operating mode is permitted for the requested traffic flows. The LLI negotiation processing component 1060 further generates and transmits a response (e.g., 520 in FIG. 5) including acceptance, rejection, or suggested modifications to the requested parameters.

In one embodiment, the compliance monitoring component 1065 is configured to monitor compliance with a negotiated LLI operating mode. More specifically, the compliance monitoring component 1065 monitors subsequent signaling and traffic transmissions, determines whether indicated traffic flows and associated parameters conform to a negotiated scope, and detects deviations or violations of the negotiated LLI operating mode.

In one embodiment, the LLI mode control and enforcement component 1070 is configured to control and enforce an LLI operating mode. More specifically, the LLI mode control and enforcement component 1070 enables, updates, or terminates the LLI operating mode for one or more traffic flows, generates corresponding control or management frames to communicate decisions, and initiates enforcement actions when non-compliance is detected.

Although depicted as a discrete component for conceptual clarity, in some embodiments, the operations of the depicted components (and others not illustrated) may be combined or distributed across any number of components. Further, although depicted as software residing in memory 1010, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including elements A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a transmit opportunity (TXOP) holder, a first control frame transmitted from a TXOP responder during a TXOP, the first control frame comprising a low latency indication (LLI) and one or more traffic-related parameters associated with a traffic flow;
determining, by the TXOP holder, whether to prioritize the traffic flow over one or more other traffic flows within a transmission queue by comparing the one or more traffic-related parameters of the traffic flow with traffic-related parameters of one or more other traffic flows;
determining, by the TXOP holder, one or more scheduling parameters for the traffic flow based on the comparison; and
transmitting, by the TXOP holder, a second control frame to the TXOP responder, the second control frame comprising the one or more scheduling parameters.

2. The method of claim 1, wherein the TXOP holder comprises an access point (AP), and the TXOP responder comprises a non-AP station (STA).

3. The method of claim 1, wherein the TXOP holder comprises a non-AP station (STA), and the TXOP responder comprises an access point (AP).

4. The method of claim 1, wherein the TXOP holder comprises a first access point (AP), and the TXOP responder comprises a second AP, and wherein the first AP and the second AP operate in a coordinated time division multiple access (Co-TDMA) mode.

5. The method of claim 1, wherein the one or more traffic-related parameters comprise at least one of a traffic identifier (TID), an access category (AC), a stream classification service identifier (SCS ID), a buffer size, or an expiry time.

6. The method of claim 1, wherein the one or more scheduling parameters comprise at least one of a resource unit assignment or a transmission timing.

7. The method of claim 1, wherein the one or more other traffic flows are associated with a transmission queue and correspond to traffic flows between the TXOP holder and the TXOP responder or traffic flows between the TXOP holder and one or more other TXOP responders.

8. The method of claim 1, wherein the first control frame comprises a multi-STA block acknowledgement (BA) frame, an acknowledgement (ACK) frame, or a buffer status report (BSR) frame.

9. The method of claim 1, wherein the second control frame comprises a trigger frame (TF) or a request-to-send (RTS) frame.

10. The method of claim 1, wherein determining whether to prioritize the traffic flow comprises prioritizing the traffic flow over the one or more other traffic flows within the transmission queue based on a traffic identifier (TID) of the traffic flow being associated with a higher priority than TIDs of the one or more other traffic flows.

11. The method of claim 1, wherein determining whether to prioritize the traffic flow comprises prioritizing the traffic flow over the one or more other traffic flows within a transmission queue based on an expiry time of the traffic flow being earlier than expiry times of the one or more other traffic flows.

12. The method of claim 1, further comprising:
in response to determining that an expiry time of the traffic flow satisfies a threshold condition, scheduling the traffic within the TXOP, or
in response to determining that an expiry time of the traffic flow does not satisfy a threshold condition, scheduling the traffic within one or more subsequent TXOPs.

13. The method of claim 1, wherein the TXOP responder, upon receiving the second control frame, is configured to conduct transmission of the traffic flow following the one or more scheduling parameters.

14. The method of claim 1, wherein the LLI and one or more traffic-related parameters associated with the traffic flow are carried within an LLI feedback element of the first control frame.

15. The method of claim 14, wherein the LLI feedback element comprises:
an LLI field carrying the LLI, and
one or more additional fields carrying the one or more traffic-related parameters, the one or more additional fields comprising at least one of a traffic identifier (TID) field, an access category (AC) field, a stream classification service identifier (SCS ID) field, a queue size subfield, or an expiry time field.

16. A method, comprising:
receiving, by a transmit opportunity (TXOP) holder and from a TXOP responder, a request frame associated with negotiation of a low latency indication (LLI) operating mode for a traffic flow, the request frame comprising one or more quality-of-service (QoS) parameters associated with the traffic flow;
determining, by the TXOP holder, whether to allow use of the LLI operating mode for the traffic flow based on the one or more QoS parameters and one or more LLI policy constraints of the TXOP holder; and
transmitting, by the TXOP holder, a response frame to the TXOP responder, the response frame indicating a result of the determination.

17. The method of claim 16, wherein the TXOP holder comprises an access point (AP), and the TXOP responder comprises a non-AP station (STA).

18. The method of claim 16, wherein the TXOP holder comprises a non-AP station (STA), and the TXOP responder comprises an access point (AP).

19. The method of claim 16, wherein the TXOP holder comprises a first access point (AP), and the TXOP responder comprises a second AP, and wherein the first AP and the second AP operate in a coordinated time division multiple access (Co-TDMA) mode.

20. The method of claim 16, wherein the request frame comprises at least one of a stream classification service (SCS) request frame, a probe request frame, an association request frame, a reassociation request frame, or a link reconfiguration request frame.

21. The method of claim 16, wherein the request frame comprises a field indicating a request to use the LLI operating mode for the traffic flow.

22. The method of claim 16, wherein the one or more QoS parameters comprise at least one of a traffic identifier (TID), an access category (AC), a stream classification service identifier (SCS ID), a delay bound, a minimum data rate, a minimum service interval, a maximum service interval, an application identifier (App ID), or a fully qualified domain name (FQDN).

23. The method of claim 16, wherein the response frame comprises at least one of:
a rejection status code indicating that use of the LLI operating mode for the traffic flow is not allowed,
an acceptance status code indicating that use of the LLI operating mode for the traffic flow is allowed, or
a rejection with suggestion status code indicating that use of the LLI operating mode for the traffic flow is conditionally allowed based on one or more modified operating-related parameters.

24. The method of claim 16, further comprising transmitting, by the TXOP holder to the TXOP responder, a second response frame to modify or terminate use of the LLI operating mode for the traffic flow.

25. The method of claim 16, wherein the response frame comprises at least one of a stream classification service (SCS) response frame, a probe response frame, an association response frame, a reassociation response frame, or a link reconfiguration response frame.

26. A system of a transmit opportunity (TXOP) holder, comprising:
one or more memories collectively containing one or more programs; and
one or more processors, wherein the one or more processors are configured to, individually or collectively, perform an operation comprising:
receiving, by the TXOP holder, a first control frame transmitted from a TXOP responder during a TXOP, the first control frame comprising a low latency indication (LLI) and one or more traffic-related parameters associated with a traffic flow;
determining, by the TXOP holder, whether to prioritize the traffic flow over one or more other traffic flows within a transmission queue by comparing the one or more traffic-related parameters of the traffic flow with traffic-related parameters of one or more other traffic flows;
determining, by the TXOP holder, one or more scheduling parameters for the traffic flow based on the comparison; and
transmitting, by the TXOP holder, a second control frame to the TXOP responder, the second control frame comprising the one or more scheduling parameters.
